(19) United States
(12) Patent Application Publication
(10) Pub. No.: US 2014/0270634 A1
(43) Pub. Date: Sep. 18, 2014

(54) MULTI- PURPOSE APPARATUS FOR SWITCHING, AMPLIFYING, REPLICATING, AND MONITORING OPTICAL SIGNALS ON A MULTIPLICITY OF OPTICAL FIBERS

(71) Applicants: Gary Evan Miller, Holly Springs, NC (US); Otis James Johnston, Raleigh, NC (US)

(72) Inventors: Gary Evan Miller, Holly Springs, NC (US); Otis James Johnston, Raleigh, NC (US)

(21) Appl. No.: 14/203,566

(22) Filed: Mar. 11, 2014

Related U.S. Application Data
(60) Provisional application No. 61/851,968, filed on Mar. 13, 2013.

(51) Int. Cl. G02B 6/35

(52) U.S. Cl. CPC G02B 6/35
USPC 385/16

(57) ABSTRACT

Several useful functions that are included in many modern day fiber optical communication systems are (1) replication of an optical signal on a single optical fiber onto a multiplicity of optical fibers, (2) amplification of optical signals, and (3) sequential switching of optical signals on a large number of optical fibers to a single or limited number of optical fibers that can each be connected to specialized performance monitoring equipment. These functions can be accomplished using a single apparatus called a multi-purpose Switched, Amplifying, Replicating and Monitoring apparatus that can manage as few as 8 optical fibers up to 512 optical fibers, or more by multiplexing.

### CROSS-REFERENCES TO RELATED APPLICATIONS

This application claims the benefit of U.S. Provisional Patent Application Ser. No. 61/851,968 filed Mar. 13, 2013, the contents of which are hereby incorporated by reference herein.

### TECHNICAL FIELD AND INDUSTRIAL APPLICABILITY OF THE INVENTION

The present invention relates to accomplishing the following three different functions that are required in many modern day fiber optical communication systems with a single innovative optical circuit: (1) replication of an optical signal on a single optical fiber onto a multiplicity of optical fibers, (2) amplification of optical signals, and (3) sequential switching of optical signals on a large number of optical fibers to a single or limited number of optical fibers that can each be connected to specialized performance monitoring equipment.

### BACKGROUND OF INVENTION

Terrestrial communications throughout the world has grown to rely heavily on optical fiber communications technology. And there is an increasing flow of signaling information that requires use of multiple optical fibers in communication links from one point to another. The various origination, termination, and relay points for optical fiber distribution systems form huge matrices—much more complicated than, say, a map of the railroads or the electrical power grid infrastructures in the United States and abroad. In fact, some optical fiber links do run along power lines and railroad right-of-ways. But, they also run under seas, across farmers' fields, down city streets, into campuses and within buildings and homes.

Management of complex fiber optic communication systems requires many different types of specialized electronic and optical equipment to ensure that correct signals are continuously being sent and received with minimum interruptions.

At a high level, these systems are controlled and monitored by sophisticated software in units called routers. However, this software must eventually reach down to actual hardware such as optical fibers, lasers, photodetectors, and optical switches. This hardware level is sometimes referred to as the physical layer of the communication system to distinguish it from the software level.

The following example shows the power of managing complex fiber systems with software at a supervisory layer to control the physical layer. If an optical signal on one fiber in a group of fibers carrying signals from point A to point B has deteriorated to an unacceptable level, possibly due to a break in this fiber somewhere along its path, sophisticated optical switches at points A and B have been developed to quickly switch the optical signal from the failed fiber over to a spare fiber that has been included in the group just for such situations. Enabling the software and hardware to automatically switch to the spare fiber eliminates the need for human intervention, which historically required hours or days to complete a repair and restore service. Now, once the system routes around the failed fiber, it can eventually be repaired by human effort in a timeframe that has no impact on the systems' performance.

Several companies, including Glimmerglass (www.glimmerglas.com), Polatis (www.polatis.com), and Calient (www.calient.net) produce such sophisticated optical switches. Their performance can be characterized by the number, N, of input fibers that can be simultaneously switched to a similar number, N, of output fibers. These switches are known as N×N optical switches. They can be instructed to connect any single input fiber to any single output fiber with no restrictions. To accomplish this task requires a total of N² internal cross-connect points within the switch. One can qualitatively understand this N² dependence by visualizing N parallel input fibers crossing at right angles to N parallel output fibers. One can easily count that these fibers intersect (cross) at N² locations. Conceptually, the switch closes an optical connection where an input fiber crosses the particular output fiber to which a connection is desired. And such connections can be easily changed over time, as required, using the system's supervisory software.

The above explanation has been simplified to emphasize the N² dependence, which relates to a switch's complexity and cost. However, it should be mentioned that these switches are typically manufactured by very specialized semiconductor processing to form micro-electro-mechanical systems (MEMS) that have an array of miniature mirrors (one for every cross-point) that tilt to make the desired optical cross-connections. The designs and processes for making and operating MEMS optical switches are covered by numerous patents, including U.S. Pat. No. 6,975,788 assigned to Lucent Technologies titled OPTICAL SWITCH HAVING COMBINED INPUT/OUTPUT FIBER ARRAYS and U.S. Pat. No. 6,917,733 assigned to Glimmerglass, Inc. titled THREE-DIMENSIONAL OPTICAL SWITCH WITH OFFSET INPUT-OUTPUT PORTS. Representative examples of state-of-the-art optical switches are made and sold by Glimmerglass, Inc. (26142 Eden Landing Road, Hayward, Calif. 94545) under the commercial name “Intelligent Optical Systems” (www.glimmerglass.com/products/intelligent-optical-systems/) Their Intelligent Optical System 100 can be configured to switch from 16×16 fibers (N=16) up to 96×96 fibers (N=96). The “Intelligent Optical System” deserves to be called “intelligent” because it includes a built in electronic controller to operate and supervise the optical switching functions. The System 100 has been designed to fit into a standard 19-inch wide instrument rack mounted unit that is 2 RUs high (3.5 inches). Glimmerglass' larger Intelligent Optical System 600 can switch up to 192×192 optical fibers and this equipment fills a rack space twice as large, 4 RUs high (7 inches).

Although the above discussion describes how a failed fiber can be quickly switched out of service and replaced by another, it did not mention how such a failure could be quickly detected in the first place. Since fiber monitoring and failure detection is an important aspect of this work, it should be mentioned that the state-of-the-art for these functions also relies on optical switching.

A good example of how monitoring and failure detection works in modern fiber optical communication systems would be the case where each signal transmission fiber has a permanent optical tap fiber attached to it that draws away a small fraction of the total signal power in the fiber, say 10%, for the purpose of monitoring. In most cases, there is not a need for continuous and simultaneous monitoring of each and every fiber. Rather, a monitoring set that is relatively expensive can be shared amongst a number of fibers in a group ranging, typically, from 8 to 512 fibers, or more. To make efficient use of the monitoring set, optical switching is used to rapidly connect the tap from any fiber within a group being monitored to a monitoring set for a limited time to complete diagnostic testing before switching to monitor another tap fiber in the group. Often, a strategy is used to monitor all of the tap fibers in a group in a specific sequence and then repeat this sequence over and over in time so that if a problem were to develop on any associated transmission fiber it would be identified within some acceptably short time interval, typically several seconds or less. To accomplish this, optical switches similar to the ones already described above can be used.

While the use of N×N optical switches for directing tapped signals to a monitoring set does work and does produce a satisfactory result, there is inefficiency and associated excess cost for doing so. That is because N×N switches, discussed above, have more capability than is required for sequentially switching N fiber taps to only one or a small number of output fibers that are connected to monitoring sets. It would be more efficient to employ specially designed switches that could switch N input fiber taps to only one or several output optical fibers that are, in turn, connected to the monitoring sets. Another way of saying the same thing is that it would be more cost-effective to use an N×M switch where M is equal to the number of monitoring sets and it is considerably less than N (M<N). Such an asymmetrical switch would have fewer cross-connections (N·M) than the N² cross-connections discussed above in a symmetrical N×N switch.

Clearly, it would be a desirable to reduce both the size and expense of the various pieces of equipment required to accomplish the desired switching and redirection of tapped optical signals to their respective monitoring set. In a seemingly unrelated aspect of operating modern fiber optical communication systems, there is often a need to divide optical signals on an optical fiber so that that the divided signals may be redirected to a multiplicity of different fibers going in different directions. This function is often referred to as signal replication or multicasting. And, not infrequently, it is necessary to reconfigure the number and directions of the fibers carrying a replicated signal. A good example where replication would be appropriate would be to send the same video signal for viewing to multiple remote locations during a conference call. Once this call was completed, there would no longer be a need to replicate this particular signal.

Signal replication is usually accomplished using specialized apparatus with optical splitters in conjunction with optical amplifiers. For example, Glimmerglass, Inc also makes and sells an apparatus know as the Intelligent Peripheral System 3000. This apparatus also has a built in controller and it has space to insert 12 modules that may be one of three different types: (1) an optical amplifier module that contains 2 erbium doped fiber amplifiers (EDFA), (2) an optical splitter module with output splits varying from 1 input fiber that splits into 2 output fibers (i.e. a 1×2 splitter) up to a 1×16 splitter, and (3) a lossless splitter module with output splits of up to a factor of 12 (output fibers) and including a built in EDFA to amplify the divided input optical signal. These modules can all be mixed and matched to various customer needs and they can be plugged into the Intelligent Peripheral System 3000 main frame, which is 6 RUs high (10.5 inches).

Glimmerglass' lossless splitter module used in their Intelligent Peripheral System 3000 is particularly useful for signal replication because it can divide a signal carried by a single input optical fiber into 12 differ output fibers. However, to do more or less splits would require human intervention to connect or disconnect selected transmission fibers or patch cords to this module. And to redistribute more than 12 signals would require additional human intervention to place patch cords that would interconnect two or more intelligent splitter modules in a cascade fashion. Since optical connections using patch cords are never perfect, one must be careful to minimize the number of connections to limit the added optical attenuation that they can introduce.

Clearly it would be advantageous if some or all such human effort could be eliminated. It would be even more advantageous if the same apparatus used for redirecting optical signals to monitoring equipment could also be efficiently used for signal replication and amplification.

Finally, it would be advantageous if the sizes of various types of equipment could be reduced so that less space would be consumed. This is especially relevant for any equipment used in remote monitoring stations because space there is particularly expensive to acquire and maintain.

Also see U.S. Pat. Nos. 7,062,167 B2, 8,014,670 B2, 8,023,819 B2 and U.S. Patent Application Publications Nos. 2004/0004709 and 2005/0180316.

### BRIEF SUMMARY OF THE INVENTION

One purpose of this disclosure is to describe an entirely new type of apparatus that can serve the multi-purposes of (1) redirecting (switching) signals on a multiplicity of optical fibers to a common monitoring set (2) amplifying optical signals and (3) replicating optical signals on a multiplicity of fibers with a multiple that can be changed in time without physical intervention by a human. If desired, this multi-purpose apparatus can be entirely dedicated to redirecting signals to a common monitoring set, amplifying optical signals, or it can be entirely dedicated to replicating signals or it can be used to perform a combination of these functions simultaneously.

Another purpose of this disclosure is to describe how these functions can be accomplished in a substantially smaller physical space than current state-of-the art equipment and with fewer optical cross-connects and fewer optical connectors that tend to introduce undesired excess optical losses.

### BRIEF DESCRIPTION OF THE DRAWINGS

FIG. 1 shows a diagram of an optical splitter assembly combined with an optical amplifier that can be used to replicate an optical signal on a single input optical fiber onto a multiplicity of output fibers.

FIG. 2 shows a diagram of an asymmetric optical switching arrangement to direct signals from a multiplicity of optical fibers to a single output fiber that could be connected to a monitoring set.

FIG. 3 shows how the functions of replicating and switching shown in FIGS. 1 and 2, respectively, can be accomplished by the same optical circuit. Replication occurs when an optical signal propagates in one direction and switching occurs when the optical signal propagates in the opposite direction. Since, this circuit unit has not been previously named, it will be referred to henceforth as the basic Switched, Amplifying, Replicating and Monitoring unit or simply the basic SwARM.

FIG. 4 shows one way a multiplicity of basic SwARM units (as shown in FIG. 3) can be combined using a modestly sized optical switch (4×4) to function together as a larger asymmetrical switch (32×4) or as signal replicator. A multiplicity of 4 basic SwARM units is show as a typical example. But, a greater or smaller number of basic SwARM units could be combined in similar or different ways.

FIG. 5 shows how a multiplicity of basic SwARM units shown in FIG. 3 can be combined to function together as an asymmetrical switch or signal replicator. A multiplicity of 8 basic SwARM units is shown in this example which can be used to monitor or replicate a total 64 individual optical fibers. This is a convenient number of fibers to be incorporated into a single apparatus that fits into 1 or 2 RUs (1.75 inches or 3.50 inches high).

FIG. 6 shows an alternative way that a multiplicity of basic SwARM units similar to the one shown in FIG. 3 can be combined to function together as an asymmetrical switch or signal replicator. In this case, a multiplicity of 4 SwARM units is shown in this example each with 16 fibers connected to an optical combiner/splitter. This combination can be used to monitor or replicate a total of 64 individual optical fibers. This is a convenient number of fibers to be incorporated into a single apparatus that fits into 1 RU (1.75 inches high).

FIG. 7 shows how the back panels of a series of units shown in FIG. 5 or 6 can be interconnected (ganged together) using electrical cables to perform coordinated switching and replication with a larger number of optical fibers. In this case 8 units each of 64 fibers are electrically interconnected so that a total of 64×8=512 optical fibers can be monitored or replicated in a single apparatus.

FIG. 8 shows how a series of units shown in FIG. 6 may be interconnected through the use of a special SwARM unit containing an 8×8 optical switch located inside of this unit's separate rack mounted enclosure.

### DETAILED DESCRIPTION OF THE INVENTION

Several useful functions that are included in many modern day fiber optical communication systems are (1) replication of an optical signal on a single optical fiber onto a multiplicity of optical fibers, (2) amplification of optical signals, and (3) sequential switching of optical signals on a large number of optical fibers to a single or limited number of optical fibers that can each be connected to specialized performance monitoring equipment. All of these functions can be accomplished using a single apparatus called a Switch, Amplifier, Replicator, Monitoring apparatus or, simply a SwARM unit that can manage as few as 8 optical fibers up to 512 optical fibers, or more by multiplexing. With reference to the attached drawings, embodiments of the present invention will be described below.

FIG. 1 shows a block diagram of an optical splitter circuit including an optical amplifier 3 that can be used to replicate an optical signal on a single input optical fiber 2 onto a multiplicity of output fibers 5. A multiplicity of eight (8) output fibers 5 are shown in FIG. 1 as being a typical number. This number may vary depending on the specific application.

In operation, an optical signal from an external fiber, not shown, is introduced into a single fiber 2 through connector 1. This signal propagates through optical fiber 2 in a clockwise direction shown by the dotted arrow 7. When the signal passes through the optical amplifier 3, it experiences optical amplification (or gain) which is normally adjusted to compensate for splitting losses (division losses) in the optical splitter that follows the optical amplifier and any other optical losses due to imperfect function of optical connectors, fibers or other optical components that may be external to the optical circuit shown in FIG. 1 that might introduce additional optical attenuation. In the example shown in FIG. 1, the optical signal in the single input fiber 2 traveling to the splitter/combiner 4 is split into eight (8) identical output signals that are carried by eight (8) output fibers 5, each with approximately equal optical power. To make up for this 8-way power division, the optical amplifier 3 would normally be set to operate with an amplification factor of 8 on a linear scale or, equivalently, 9 dB on a logarithmic power scale. Of course, optical splitters manufactured with splitting ratios different from 8 can be used. For example, splitting rations of 2, 4, 8, 16 etc. are frequently used in single mode optical circuits because they can be manufactured with relative ease by using planar integrated optical manufacturing techniques that divide a single surface optical waveguide into two equal guided paths using a “Y” shaped structure on a planar substrate typically made of high purity fused silica (SiO₂) and using a dopant, like silver oxide, to define the “Y”. Then, each of these paths can be split again and again, producing 8 output paths after 3 such two-way splits and 16 output paths after 4 such splits. The surface waveguides in such an integrated optical splitter may be terminated in direct proximity to the core of a single mode optical fiber to minimize optical coupling loss at the interfaces between the single input optical fiber 2 and between the multiplicities of output optical fibers 5. Each optical fiber 5 is terminated with an optical connector 6 at the output of this circuit.

Although the above discussion emphasized components that are compatible with single mode optical fibers like the industry standard SMF-28 fiber that has been designed and is produced by Corning Glass Works, the optical circuit shown in FIG. 1 is not limited to use of only single mode fibers. Rather, it is general enough to be used not only with single mode fibers but also with multi-mode fibers as well as single mode polarization preserving fibers that are well know in the fiber optics industry.

FIG. 2 is a block diagram of a rather different optical circuit that can switch a multiplicity of optical signals with one such signal on each of a multiplicity of input fibers 5. Each of the multiplicity of input optical fibers is interrupted by a 1×1 optical switch 9. These 1×1 switches typically have a very simple mechanical design employing an electronically switched magnetic field to move the output fiber 5a from its “on” to “off” position or vice versa. That is the sole function of a 1×1 optical switch. Due to their simple construction, these 1×1 switches 9 are substantially more cost effective than the larger N×N switches (where N is a large number) that are made using the Micro Electo-Mechanical System (MEMS) fabrication techniques described in the BACKGROUND OF INVENTION.

The signal outputs from all optical fibers 5a are directed to an optical splitter/combiner 4. And the output of the splitter combiner is directed to a single fiber 2 that guides the output to connector 1. In operation, all of the 1×1 switches 9 but one are turned to their “off” state so that an optical signal from only one of the multiplicity of input fibers 5, having its corresponding switch in the “on” state, propagates through fiber 2 in the direction of the arrows 8 to the output connector 1. It should be noted that an optical amplifier is not normally required in this circuit because only one optical signal at a time passes through the splitter/combiner 4, in some cases, with very little attenuation. Here again, the type of optical fibers and components used in this circuit may be standard single mode type, multi-mode type, or polarization preserving type. A significant utility for this circuit is that it can be used to sequentially switch optical fibers from a multiplicity of input fibers to a single output that may be connected by a patch cord optical fiber (not shown) to a signal monitoring set (not shown) so that a failure or degradation of any optical signal may be quickly detected, typically, in only a fraction of a second to several seconds.

Even though an optical amplifier is not required in the circuit shown in FIG. 2, there could be an advantage in including one as an option to compensate by using optical amplification for various optical losses due to imperfect function of optical connectors, fibers or other optical components that may be external to the optical circuit shown in FIG. 2 that might introduce additional optical attenuation.

FIG. 3. is yet another block diagram of an optical circuit that can perform all of the functions of the two circuits shown in FIGS. 1 and 2. When the optical signal propagates in the direction of the arrow 7, this circuit serves as an optical replicator circuit. When the optical signal propagates in the opposite direction 8, this circuit serves as a switch or amplifier or both. The fact that this single circuit can perform seeming unrelated dual functions is remarkable. It has been named the basic SwARM circuit unit and, like the circuit units shown in FIGS. 1 and 2, it can employ single mode fibers, multi-mode fibers or polarization preserving fibers.

There are several factors to be considered in selecting a suitable optical amplifier 3 to be included in the circuit shown in FIG. 3. First, since most amplifiers operate only over a limited range of optical signal wavelengths, it is important to select an amplifier that has sufficient gain to overcome any splitting (division) losses due to the splitter/combiner 4. For example, the popular erbium doped fiber amplifier (EDFA) which exhibits high maximum optical gains is limited in operation wavelengths to a range between 1.50 to 1.60 microns. This includes the commercially important C-band that extends from 1.521 to 1.560 microns. The thulium doped amplifier fiber amplifier (TDFA) operates between 1.46 and 1.51 microns. In contrast, Raman and Brillouin fiber amplifiers operate over a substantially broader range of wavelengths but, typically, exhibit a lower maximum gain than the EDFA. Semiconductor optical amplifier typically exhibits both a broader range of operating wavelengths, 0.8 to 2.00 microns, and high maximum gain. However, additional complexity is involved in connecting such a planar optical amplifier to input and output optical fibers. Further, the semiconductor amplifiers tend to cause inter-modulation cross-talk if multiple optical wavelengths are carried by a single fiber as is now common using wave length division multiplexing (WDM).

A second factor to be considered in the selection and use of optical amplifiers is to recognize that some optical amplifiers exhibit higher optical gain for optical signals propagating through them in one direction than in the opposite direction. If an amplifier is used with unequal gains in different directions of propagation, it should always be placed in the optical circuit shown in FIG. 3 so that the propagation direction with the greatest maximum gain is in direction 7 to overcome the division losses that occur when the signal is split by the splitter/combiner 4.

FIG. 4 shows how four (4) Basic SwARM circuits may be coupled together using a 4×4 optical switch 10. The 1×1 switches shown as optical switches 9 in FIG. 3 remain included in each of the four circuits shown in FIG. 4. But, due to their relatively small size, they are not numbered in this figure. In this example, there are eight (8) optical fibers associated with each of the four splitter/combiners 4a, 4b, 4c, and 4d resulting in a total fiber count of 32 optical fibers (4×8=32) that can be used for switching, amplifying, replicating or monitoring.

If the circuit in FIG. 4 is used for optical switching, the optical signal on any one of the 32 input fibers may be switched to a single output fiber 11. If that particular optical signal passes though, for example, splitter/combiner 4c, it would be possible to have simultaneous optical signals that pass through splitter combiners 4a, 4b, and 4d directed to output fibers 12, 13, and 14 in any combination of interconnections that is desired. Thus, one could connect fibers 11, 12, 13, and 14 to four different optical fiber monitoring sets so that at any time any 4 of the 32 input fibers show in FIG. 4 could be simultaneously monitored.

When the optical circuit shown in FIG. 4 is used for replication, fibers 11, 12, 13, and 14 would be considered to be signal input fibers. If an identical signal were introduced on all four of these fibers, replicated signals would be produced on all 32 output fibers, assuming that all of the 1×1 optical switches associated with these fibers were turned “on”. Alternatively, the number of replicated signals could be reduced by turning “off” any combination of the 32 optical switches associated with each of these output fibers. The circuit shown in FIG. 4 could also be used to replicate up to 4 different optical signals introduced to fibers 11, 12, 13, and 14. In this case, each of the signals to be replicated would be directed to one of the four splitter/combiners 4a, 4b, 4c, or 4d and be replicated up to 8 times as signals on the eight output fibers associated with a particular splitter/combiner. In summary, up to four optical signals could be simultaneously replicated onto up to 32 output fibers. The only limitation would be that replication would take place in output groups of eight fibers in the case of the specific circuit shown in FIG. 4. However, different combinations would also be possible by combining more or less than four basic SwARM circuits or using more or less than eight optical fibers per splitter/combiner. Examples of such alternatives are shown in FIGS. 5 and 6 that are described next.

FIG. 5 is a block diagram showing one way that a total of eight basic SwARM circuit units can be combined. In this figure there are a total of 64 fibers at the multi-fiber ports of the eight splitter/combiners shown. This has been found to be a convenient grouping that can fit into a single rack mounted apparatus that is only 1 or 2 RU (1.75 inches or 3.50 inches) high. In this case, the SwARM apparatus operates as two independent units with 32 optical fibers each. Both of these units could be used for switching or replicating. Alternatively, one of the 32-fiber units could be used for switching and the other used for replicating.

FIG. 6 shows an alternate way to connect four basic SwARM circuits with a 4×4 optical switch 10. Using this arrangement, any of the 64 optical fibers 51 connected to the four 16×1 splitter/combiners 41 can be selectively switched using optical switches 91 on a path 81 through output fibers 51, optical amplifier 31, optical fiber 21 and switch 10 to any of the four output fibers 111, 112, 113, and 114 from the optical switch 10. When used for signal replication, any optical signal introduced on any of the four input fibers 111, 112, 113, and 114 can be replicated by a factor of up to 16 on the outputs of any single splitter/combiner. And if the same optical signal were introduced into all four fibers 111, 112, 113, and 114, replication of up to a factor of 64 would be possible.

FIG. 7 shows how eight different rack mounted apparatuses similar to the ones shown in either FIG. 5 or 6 can be interconnected with electrical cables 60 from electrical output ports 70 to input ports 80 on the back panels of these apparatuses.

When a single apparatus such as those shown in FIGS. 5 and 6 are used individually, each such apparatus must include an electrical controller within its rack-mounted enclosure to operate all of the various optical switches and to control the performance of the optical amplifiers. This controller would normally be interconnected to an graphical interface unit (GUI) located outside of the apparatus enclosure through electrical cables using any of a number of convenient interface protocols such as HTML 5 for fast response. However, when a multiplicity of apparatuses are used as in FIG. 7, it is possible, for reasons of economy, to make only one of the eight apparatuses contain the primary control electronics and all of the electronics need to interface with the external GUI. In FIG. 7, unit 100 has this capability and is designated as the primary apparatus. The other seven apparatuses 200, 300, . . . 800 are designated as secondary units and they only contain a sufficient amount of electronics to properly interface with the primary unit through cables 60. Since both the primary and secondary units each have a total of 64 fibers at the output of their splitter/combiners, a stack of eight such apparatuses can be used to manage a total of 512 optical fibers (8×64=512) in groups of 64 each.

FIG. 8 shows an alternate interconnection scheme for multiple apparatuses shown in FIG. 6. Specifically, optical jumper cables 120 are used to interconnect these apparatuses as shown in FIG. 8, using a single-port optical connector on apparatuses 100, 200, 300, 400, 600, 700, and 800 with cables that terminate on apparatus 500 at a multiport optical connector 6. Using this arrangement and including an 8×8 optical switch within apparatus 500, it is possible to set the internal switches so that any or the 64 input fibers in any of the eight apparatuses shown in FIG. 8 can be connected to any of eight fiber output ports on apparatus 500. Using such an arrangement would allow the monitoring of all 512 fibers (8×64=512) on any of 8 fiber output connectors on apparatus 500 either individually or simultaneously.

While the above drawings provide representative examples of specific embodiments of the inventive SwARM optical circuit, there are numerous variations on the way multiple circuits of this nature can be combined within a single equipment enclosure to accomplish beneficial functions in modern optical communication systems.

What is claimed is:

1. An apparatus that contains a single fiber optical circuit, known as a basic SwARM circuit that can perform multiple functions of (1) switching, (2) amplifying, and (3) replicating of optical signals depending on which direction optical signals propagate through this circuit that is comprised of a multiplicity of optical fibers that can be individually turned on and off with 1×1 optical switches and this multiplicity of fibers is connected to one side of an optical combiner/splitter that has a single fiber on the other side of the combiner/splitter that is connected to an optional optical amplifier followed by the continuation of the said single optical fiber to a connector.

2. An apparatus that contains two or more basic SwARM circuits that are each comprised of a multiplicity of optical fibers that can be individually turned on and off with 1×1 optical switches and that this multiplicity of fibers is connected to one side of an optical combiner/splitter having a single fiber on the other side of the combiner/splitter that is connected to an optional optical amplifier followed by the continuation of the said single optical fiber and that the two or more basic SwARM circuits are interconnected with at least one multiport optical switch that can switch between each of the said single fiber continuations of the individual basic SwARM circuits.

3. An apparatus in claim 2 in which the optical fibers are single mode optical fibers.

4. An apparatus in claim 2 in which the optical fibers are multimode optical fibers.

5. An apparatus in claim 2 in which the optical fibers are polarization preserving single mode fibers.

6. An apparatus in claim 2 in which the optical amplifiers are erbium doped fiber amplifiers (EDFA).

7. An apparatus in claim 2 in which the optical amplifiers are semiconductor optical amplifiers (SOA).

8. An apparatus in claim 2 in which the optical amplifiers are either Raman or Brillouin optical amplifiers or a combination of these two amplifier types.

9. An apparatus as in claim 2 that contains up to 8 basic dual switch/replicator units and fits into a standard 19 inch wide instrument rack.

10. An apparatus as in claim 9 that is 1 RU (1.75 inches) high.

11. An apparatus as in claim 9 that is 2 RU (3.50) inches high.

12. An apparatus as in claim 9 that includes an internal electronic module that can control all of the optical switches and optical amplifiers within the apparatus.

13. An apparatus as in claim 12 that is 1 RU (1.75 inches) high.

14. An apparatus as in claim 12 that is 2 RU (3.50) inches high.

15. An apparatus as in claim 12 that includes an internal electronic module that can control all of the optical switches and optical amplifiers within the apparatus through a graphic user interface (GUI).

16. A primary apparatus as in claim 9 that includes an internal electronic module that can control all of the optical switches and optical amplifiers within the apparatus and also within one or more similar secondary apparatuses that do not have dedicated controllers and that the primary and secondary apparatuses are interconnected by use of electrical cables.

17. An apparatus as in claim 2 in which the said multiport switch is connected so that the optical signal propagating through any one of the multiplicity of fibers connected to 1×1 switches in one of more basic SwARM circuits can be directed to a single output port of the said multiport optical switch.

18. An apparatus as in claim 9 in which the said multiport switch is connected so that the optical signal propagating through any one of the multiplicity of fibers connected to 1×1 switches in one of more basic SwARM circuits can be directed to a single output port of the said multiport optical switch.

19. An apparatus as in claim 12 in which the said multiport switch is connected so that the optical signal propagating through any one of the multiplicity of fibers connected to 1×1 switches in one of more basic SWARM circuits can be directed to a single output port of the said multiport optical switch.

20. An apparatus as in claim 15 in which the said multiport switch is connected so that the optical signal propagating through any one of the multiplicity of fibers connected to 1×1 switches in one or more basic SwARM circuits can be directed to a single output port of the said multiport optical switch.

21. An apparatus as in claim 2 in which at least one of the said basic SwARM circuits is used for signal monitoring.

22. An apparatus as in claim 2 in which at least one of the said basic SwARM circuits is used for signal replication.

23. An apparatus that contains two or more basic SwARM circuits that are each comprised of a multiplicity of optical fibers that can be individually turned on and off with 1×1 optical switches and that this multiplicity of fibers is connected to one side of an optical combiner/splitter having a single fiber on the other side of the combiner/splitter that is connected to an optional optical amplifier followed by the continuation of the said single optical fiber and that the two or more basic SwARM circuits are interconnected with at least one multiport optical switch that can switch between each of the said single fiber continuations of the individual basic SwARM circuits and in which at least one of the said basic SwARM circuits is used for signal monitoring and at least one of the remaining basic SwARM circuits is used for signal replication.
